(19) United States
(12) Patent Application Publication
(10) Pub. No.: US 2011/0093192 A1
(43) Pub. Date: Apr. 21, 2011

(54) APPLICATION APPARATUS, SERVER, SYSTEM AND METHOD OF TRAVEL SERVICE

(75) Inventors: Hui-Kuo Yang, Hsinchu County (TW); Che-Wei Liang, Taichung County (TW); Yu-Hsiang Chuang, Taoyuan County (TW); Chi-Chun Kao, Taipei City (TW); Po-Wen Wang, Chiayi City (TW)

(73) Assignee: INDUSTRIAL TECHNOLOGY RESEARCH INSTITUTE, Hsinchu (TW)

(21) Appl. No.: 12/903,216

(22) Filed: Oct. 13, 2010

Related U.S. Application Data
(60) Provisional application No. 61/253,085, filed on Oct. 20, 2009.

(30) Foreign Application Priority Data
Aug. 13, 2010 (TW) 99127136

(51) Int. Cl. G06F 15/16; G06Q 10/00; G01C 21/00; G06F 17/30

(52) U.S. Cl. 701/207; 709/227; 707/769; 707/E17.014; 705/7.14

(57) ABSTRACT

A system of travel service is provided. The system includes an application apparatus and a server. A traveler sends a request through the application apparatus when a problem occurs during his/her trip. A helper who has communication capability of a specific language used by the traveler is found by the server in real time. The server sends information related to the request to the helper immediately. A live connection between the traveler and the helper is created in real time to provide travel services to satisfy the request, in which the live connection includes real-time voice communication and real-time data communication. The problem which occurred during the traveler's trip can be solved quickly by the present system.

### CROSS-REFERENCE TO RELATED APPLICATION

This application claims the priority benefit of U.S. provisional application No. 61/253,085, filed on Oct. 20, 2009. The entirety of the above-mentioned patent application is hereby incorporated by reference herein and made a part of this specification.

### BACKGROUND

1. Technical Field

The disclosure relates to a method of travel service, and more particularly to an application apparatus, a server, a system, and a method of travel service capable of creating a live connection between a traveler and a helper to provide real-time travel services.

2. Description of Related Art

Due to factors such as unfamiliarity with foreign environments as well as language barriers, travelers often require assistance during their visits. For example, lost of directions, menu reading, taking the mass transit, finding a nearest restaurant or shopping center are common scenarios where a traveler's problems can be easily solved by a helper well versed in the local language and culture, while being able to communicate with the traveler. In another example, when foreign tourists travel to Taiwan and hire taxis, the taxi drivers often need to call out to friends or colleagues fluent in the foreign languages in order to assist in the confirmation of the destination.

U.S. Patent Application Publication No. 2009/0157613 discloses a method for creating a travel community, in which travelers form communities based on the same travel destinations so as to share their travel experiences and to mutually assist each other. U.S. Pat. No. 7,383,190 discloses a system and a method in which travelers fill out electronic forms to communicate with travel experts at the travel destination, so as to obtain relevant travel information. U.S. Patent Application Publication No. 2009/0005018 discloses a system for route sharing and searching for travelers on a travel route, which is based on the sharing of travel locations and emphasizes on creating relationships between travelers. The aforementioned disclosures are not suitable for the previously described scenarios in which the traveler requires assistance. Therefore, a system is needed to assist a traveler to rapidly find a real-time helper well versed in the local culture and speaking the traveler's native language, and to create a live connection between the traveler and the helper, so as to solve problems met by travelers during their visits.

### SUMMARY

A method of travel service is introduced herein, adapted for a system of travel service comprising a server and an application apparatus, the method of travel service comprising the following steps. A traveler sends a request through the application apparatus, and the server finds a real-time helper. The real-time helper has a communication capability of a specific language used by the traveler. The request is sent to the real-time helper. Moreover, a live connection between the real-time helper and the traveler is created to provide travel services to satisfy the request, in which the live connection comprises real-time voice communication.

Another method of travel service is introduced herein, adapted for a system of travel service comprising a server and an application apparatus, the method of travel service comprising the following steps. A traveler sends a request through the application apparatus, and the server provides a plurality of candidate helpers. The candidate helpers have the communication capability of the specific language used by the traveler. The request is sent to the candidate helpers. When one of the candidate helpers accepts the request, then the candidate helper accepting the request is selected as a real-time helper. Moreover, a live connection between the real-time helper and the traveler is created to provide travel services to satisfy the request, in which the live connection comprises real-time voice communication.

A system of travel service comprising an application apparatus and a server is introduced herein. A traveler sends a request through the application apparatus, and the server finds a real-time helper having the communication capability of the specific language used by the traveler. The system of travel service creates a live connection between the traveler and the real-time helper to provide travel services to satisfy the request, in which the live connection comprises real-time voice communication.

An application apparatus of travel service is introduced herein, adapted for a system of travel service further comprising a server. After a traveler sends a request through the application apparatus, the server finds a real-time helper having the communication capability of the specific language used by the traveler. The system of travel service creates a live connection between the traveler and the real-time helper to provide travel services to satisfy the request, in which the live connection comprises real-time voice communication.

A server of travel service is introduced herein, adapted for a system of travel service, the system of travel service further comprising an application apparatus. After a traveler sends a request through the application apparatus, the server finds a real-time helper having the communication capability of the specific language used by the traveler. The system of travel service creates a live connection between the traveler and the real-time helper to provide travel services to satisfy the request, in which the live connection comprises real-time voice communication.

Several exemplary embodiments accompanied with figures are described in detail below to further describe the disclosure in details.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a block diagram of a system of travel service according to an embodiment of the disclosure.

FIG. 2 is a flowchart of a method of travel service according to an embodiment of the disclosure.

FIG. 3 is a flowchart of a method of travel service according to another embodiment of the disclosure.

FIG. 4 is a flowchart of a method of interactive navigation according to an embodiment of the disclosure.

FIG. 5 is a schematic view depicting a usage scenario of the disclosure applied in destination recommendation and direction guidance.

FIG. 6 is a schematic view depicting a usage scenario of the disclosure applied in interactive navigation.

FIG. 7 is a schematic view depicting a usage scenario of the disclosure applied in designating a rendezvous point.

FIG. 8 is a schematic view depicting a usage scenario of the disclosure applied in menu translation and explanation.

### DESCRIPTION OF EMBODIMENTS

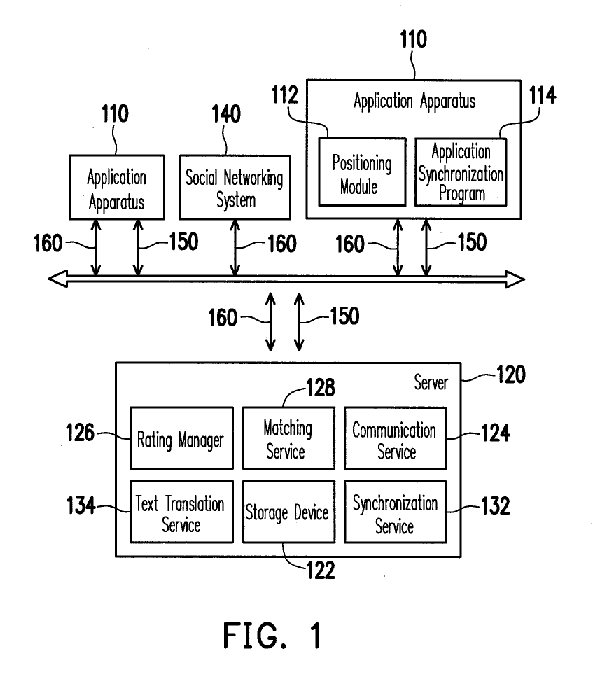

An embodiment of the disclosure provides a system of travel service as shown in FIG. 1. FIG. 1 is a block diagram of a system of travel service according to an embodiment of the disclosure. Please refer to FIG. 1. The system of travel service includes an application apparatus 110, a server 120, and a social networking system 140. The server 120 includes a storage device 122, and the server 120 provides a communication service 124, a rating manager 126, a matching service 128, a synchronization service 132, a text translation service 134, and other services. The application apparatus 110 includes a positioning module 112. Moreover, a client application program in the application apparatus 110 includes an application synchronization program 114 capable of operating independently or collaborating with the synchronization service 132 of the server 120, in order to synchronize the information between the client application programs of two application apparatuses 110, or the information between the server 120 and the application apparatus 110. The application apparatus 110, the server 120, and the social networking system 140 may be connected to each other through all types of networks such as a wired, wireless, or a fiber network, and so on. Between the server 120 and the application apparatus 110, or between two application apparatuses 110, a voice communication channel 150 and a data communication channel 160 may be employed to transmit data or to make a real-time voice communication call. For example, two application apparatuses 110 may employ an available communication method to communicate in a common language, or a Wifi, Wimax, 3.5G, or other wireless broadband access networks may be employed for the connection.

The application apparatus 110 may be a personal computer or mobile devices such as a mobile phone, a notebook computer, or a personal digital assistant (PDA). The client application program in the application apparatus 110 detects a traveler's position through the positioning module 112. For example, through a Global Positioning System (GPS) receiver, a Global System for Mobile Communication (GSM) positioning, a Wifi positioning, a Wimax positioning, an IP positioning, or a user-selected software or hardware positioning method, the current position of the application apparatus 110 can be determined However, the positioning method is not limited to the foregoing description.

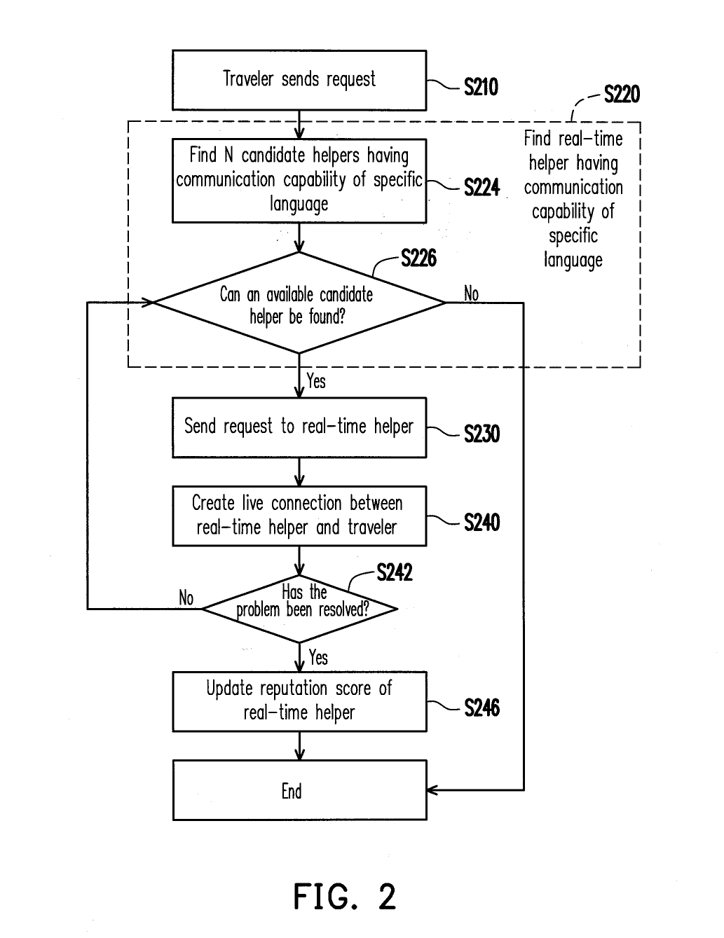

FIG. 2 is a flowchart of a method of travel service according to an embodiment of the disclosure. Please refer to both FIGS. 1 and 2. In a Step S210, when the traveler is faced with a problem and requires assistance, the traveler sends a request by executing the client application program in the application apparatus 110. Thereafter, in a Step S220, after the server 120 receives the request, the matching service 128 in the server rapidly finds a suitable real-time helper. Naturally, the real-time helper needs to have a communication capability of a specific language used by the traveler. For example, a local real-time helper that is well versed in the local culture and capable of speaking the local language as well as the traveler's native language.

The Step S220 may be further divided into Steps S224 and S226. In the Step S224, the server 120 first provides a plurality of candidate helpers having the communication capability of the specific language used by the traveler. For example, from a database in the storage device 122 of the server 120, the top N candidate helpers having the best reputation, or the N candidate helpers most suitable to the request sent from the traveler are found, in which N is a positive integer greater than 1. Besides comparing a language condition, the matching service 128 of the server 120 may also use other conditions to search for candidate helpers in the database, such as interests, food, age, reputation score, and so on. Moreover, a possible candidate helper list may be found by filtering information such as distance apart or online status obtained from the server 120.

Thereafter, in a Step S226, whether a candidate helper is available among the candidate helpers is determined. People that have been contacted or have been deselected by the traveler do not qualify as an available candidate helper. If a candidate helper is available, then one of the available candidate helpers is chosen or one is sequentially chosen as the real-time helper. When no candidate helpers are available, then the traveler is notified and the matching service is terminated. In another embodiment, when a real-time helper cannot be found from the candidate helpers, the real-time helper may be selected from the service personnels of a service center (not drawn) provided by the system.

An embodiment is described hereafter illustrating a determination of the availability of the candidate helpers, although the disclosure should not be construed as limited thereto. The embodiment uses the online statuses of the candidate helpers, available or busy, to determine whether the candidate helpers are available. When the candidate helpers turn on the application apparatus or use a browser to log on to a web interface provided by the system on the Internet, an event handler software component (not drawn) or an event management system of the web interface detects that the candidate helpers have statuses open for service and are available to receive the traveler's problems. When a candidate helper is assigned by the server to provide services to a particular traveler, the candidate helper is marked as busy and thus temporarily unavailable to receive any new problems.

In a Step S230, the request sent by the traveler, or a relevant information corresponding to the request is transmitted to the real-time helper, so as to notify and facilitate the real-time helper's understanding and preparation of the relevant information pertaining to the problem. In a Step S240, a live connection between the traveler and the real-time helper is created in real-time. The live connection includes real-time voice communication in which the real-time helper can provide travel services to satisfy the request. The live connection may be connected through the communication service 124 provided by the server 120, or the real-time helper and the application apparatus 110 used by the traveler may be directly connected to each other. As long as the real-time helper and the traveler can communicate freely, the solution to the problems met by the traveler can be facilitated. For example, the application apparatus 110 of the traveler is a notebook computer, the application apparatus 110 of the real-time helper is a personal computer, and both of the application apparatuses 110 of the two parties have executed the client application program provided in the disclosure. The two parties may use Wifi, Wimax, 3.5G, and other wireless broadband access networks to access the Internet and connect using a real-time communication software. Moreover, identification information of the other party may be displayed on the application apparatuses 110, such as telephone number and name. An available telecommunication network or a Voice over Internet Protocol (VoIP) communication method may be used to place a call. In the Step S242, whether the problem corresponding to the request of the traveler has been resolved is determined. Although the real-time helper and the traveler have terminated the connection therebetween, but in case the problem of the traveler has not been resolved, then the process returns to the Step S226, in which another available real-time helper is selected among the aforementioned candidate helpers. Thereafter, the Steps S230 and S240 are repeated. If the traveler's problem has not been resolved after a limited number of helper selection loops, then one of the service personnels of the service center provided by the system is selected as the real-time helper. In the Step S246, when the problem corresponding to the request of the traveler has been resolved, the application apparatus 110 displays a screen for the traveler to provide feedback. With the traveler inputting a reputation score related to the real-time helper, or a dual positive/negative rating, the server 120 may store a data related to the satisfaction of the traveler in the storage device 122, in order to compile statistics and to evaluate the reputation of the real-time helper.

The rating manager 126 in the server 120 compiles and evaluates the reputation of the helper. The reputation of helper may be determined by two factors, one being an average number of service cases performed by the helper, and two being a ratio of positive ratings received. As the number of cases received by the helper increases, the helper is more prominently displayed as active. Moreover, as the helper receives more positive ratings, the service content provided by the helper is displayed as more trustworthy. The rating manager 126 considers these two factors comprehensively to calculate the reputation score of the helper, and to provide the matching service 128 a reference for matching comparison.

A calculation method of the first factor is compiling a number of cases received within a unit time. The unit time may be set to one day, one week, 10 days, two weeks, and so on, dynamically adjustable by the server 120 according to a flow rate during the service operation. A calculation method of the second factor may be employing a simple dual positive/negative rating, for example inquiring the traveler whether the service was satisfactory through the application apparatus 110. When the traveler terminates the service, the application apparatus 110 pops out a satisfaction inquiry interface in real time where the traveler can give a rating or abandon the rating process. After the rating is given, the application apparatus 110 sends the rating to the server 120 for statistics compilation in real time, and the server 120 automatically calculates the ratio of positive ratings the helper received. The rating score of the helper is a weighting adjusted by the proportions occupied by the two factors. Assuming the weights of the two factors are respectively ω₁ and ω₂, the reputation score is S, the average number of cases is X, and the positive rating score is Y, then the reputation score of the helper is calculated as S=ω₁X+ω₂Y, where ω₁ and ω₂ are dynamically set and adjusted according to the data accumulated during the service operation, thereby achieving preferable trustworthiness and impartiality for the reputation score.

The social networking system 140 is connected with other devices or systems through the data communication channel 160, such that travelers may socially interact with locals at each travel destination, or travel experiences may be shared between the travelers after their visits. Moreover, the social networking system 140 may be used to create and maintain a helper database stored in the storage device 122 of the server 120. For example, a basic information profile of a helper can be created based on his or her behaviors on the social networking system 140, such as activities engaged or topics interested in. Helper database also includes regular updated information for a helper based on the satisfaction feedbacks received from the traveler after assistance and the input of the reputation score, and so on. In the aforementioned Step S224, the server 120 searches in the database the N candidate helpers of the highest reputation scores and having the communication capability of the specific language used by the traveler, thereby finding the top N candidate helpers having the best reputations. Alternatively, the N candidate helpers with expertise most suited to the request sent by the traveler may be found by the categories of the database. A preferable service environment occurs when a large number of people are using the system of travel service according to the disclosure. Therefore, currently available social networking systems such as

Facebook may be employed to effectively increase the number of users, so as to conveniently provide one of the several communication mechanisms appeared in this disclosure between the travelers and the locals. The server 120 further provides the text translation service 134, which can translate whole sentences of text published on the social networking network 160 by any user, in real time, to understandable text to other users. Likewise, the other users can also respond in their native languages, and the response is then translated into text of different languages. With the text translation service 134, users of different languages can interact on the social network through a travel theme.

Although the embodiment employs the social networking system 140 as an example, the disclosure is not limited thereto. The disclosure does not require the social networking system 140 in order to operate. Other methods of interaction between parties and database creation are within the protected scope of the disclosure, for example by using a questionnaire inquiry or an advertisement seeking potential applicants. The server 120 according to the embodiment includes services such as the text translation service 134, although the disclosure is not limited thereto. Not all the services described need to be included in the disclosure, for instance the text translation service 134 is a supplementary function serving to enhance a usage convenience.

An example for applying the disclosure is illustrated hereinafter. At an airport, a foreign traveler first rents a mobile phone provided by the disclosure, or executes the client application program provided by the disclosure in a self-owned cell phone, and sets a language used by the traveler. When assistance from locals is required during travels, for example, the traveler wants to try specialty foods or visit tourist sights nearby, the foreign tourist presses a special function button on the cell phone. The cell phone transmits this request to the system of travel service in the disclosure. The system searches a list of all the locals capable of helping the traveler, ranks the names on the list in order, and sends the request related information to the locals in sequence. When the request related information cannot be successfully transmitted, or the system cannot find any locals capable of helping, the request is diverted to the service center. When the request related information is successfully transmitted, then the system creates voice and data communication channels between the traveler and the locals, and begins to provide services to solve the problems of the traveler. For example, when the traveler orders a meal and takes a photo of the menu, the menu photo is automatically transmitted to the mobile phone of a local, and accordingly the local assists the traveler in the order of the meal and other services by voice communication. When the provided service is completed, the system asks the traveler whether the problem has been properly resolved. If yes, then the rating of the local is adjusted according to the satisfaction of the service. If the problem has not been resolved, then the request is transferred to the next suitable local or diverted to the service center.

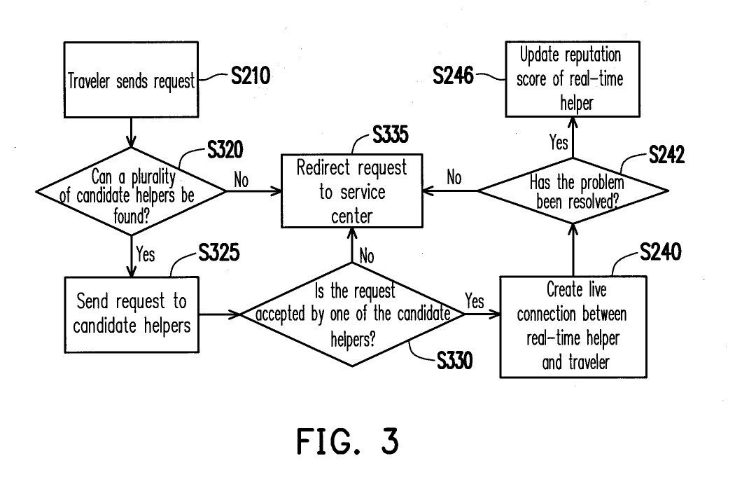

FIG. 3 is a flowchart of a method of travel service according to another embodiment of the disclosure. Please refer to both FIGS. 1 and 3. The method of travel service of the embodiment depicted in FIG. 3 is similar to the method depicted in FIG. 2, and so the similar aspects are omitted hereafter. The differences in the method of travel service according to the present embodiment are illustrated hereafter. After the traveler sends the request through the application apparatus, in a Step 320, the method determines whether the server can find a plurality of candidate helpers. The method of finding the plurality of candidate helpers having a communication capability of a specific language are similar to the aforementioned Step S224, and therefore the description thereof is omitted hereafter. When the candidate helpers are found, a Step S325 is executed. In the Step S325, the request or the information related to the request is directly sent to the candidate helpers. The request may be sent one by one in sequence according to the reputation score of the candidate helpers, or the request may be sent to a predetermined number of candidate helpers at once. In a Step S330, when one of the candidate helpers accepts the aforementioned request, then the helper accepting the request becomes the real-time helper, and the process executes the Step S240. In other words, a live connection between the traveler and the real-time helper is created in real-time, so as to provide travel services satisfying the aforementioned request.

When candidate helpers are not found in the Step S320, or no candidate helper agrees to accept the request in the Step S330, or the live connection in the Step S242 did not resolve the problem, then a Step S335 is executed. In the Step S335, the request is redirected towards the service center. For example, one of the service personnels of the service center is selected as the real-time helper, and the request is sent thereto. In addition, the request may be sent to all of the service personnels of the service center, thus resolving the problem through a service personnel with experience and availability.

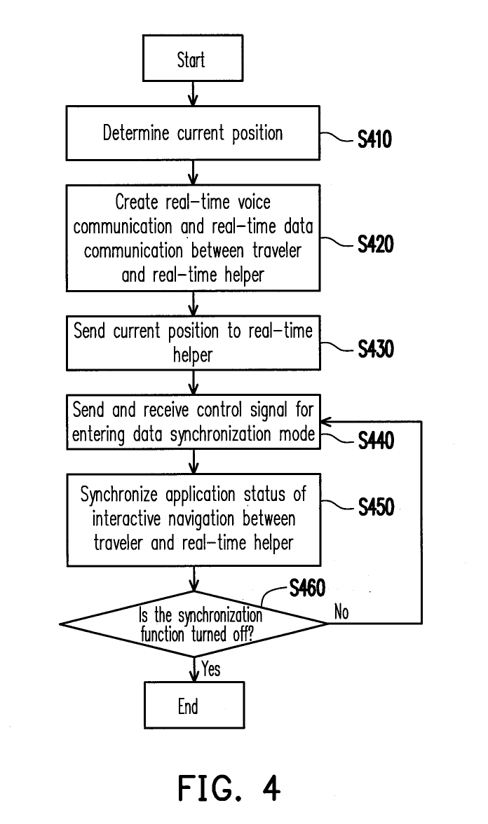

According to the afore-described method, after the live connection between the traveler and the real-time helper is created, the system of travel service in the disclosure can be employed to engage in interactive navigation. FIG. 4 is a flowchart of a method of interactive navigation according to an embodiment of the disclosure. Please refer to both FIGS. 1 and 4. The server 120 further includes the synchronization service 132 for synchronizing the application status of the application apparatuses 110 of the traveler and the real-time helper, so as to engage in interactive navigation.

In a Step S410, the traveler uses the client application program in the application apparatus 110, and a current position of the traveler is detected and positioned through the positioning module 112 on the application apparatus 110. In a Step S420, the application apparatus 110 creates a live connection with another application apparatus 110 with the assistance of the server 120, and creates the voice communication channel 150 and the data communication channel 160 between two client application programs to transmit data, voice communication, and so on in real time. In other words, a live connection including real-time voice and data communication is created between the traveler and the real-time helper. In a Step S430, the application apparatus 110 sends the current position of the traveler to the real-time helper. Alternatively, the location data of the traveler and the real-time helper themselves are transmitted to the client application program of the other party. In a Step S440, a control signal and data are transmitted and received for entering the data synchronization mode. In other words, a data synchronization control message from the application program of the other party is received, and a data synchronization control message thereof is transmitted to the other party, so as to maintain data synchronization. In a Step S450, after the data synchronization control message of the other party is received, the client application program updates the status thereof, thereby synchronizing the application status of the interactive navigation between the application apparatus 110 of the traveler and the real-time helper. Thereafter in a Step S460, whether the synchronization function is turned off is determined. When the function is not turned off, then the process returns to Step S440 to continue receiving the synchronization data.

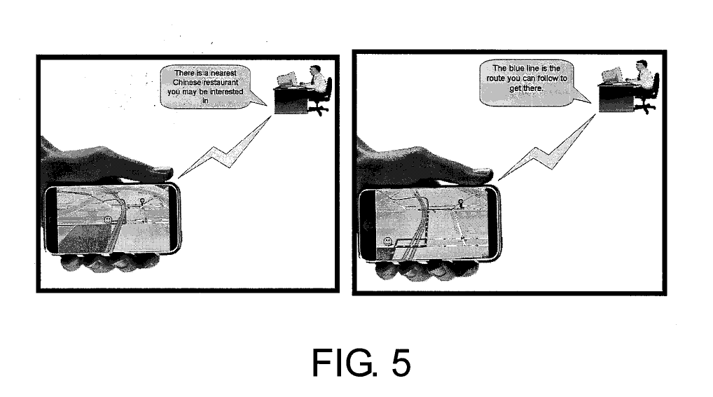

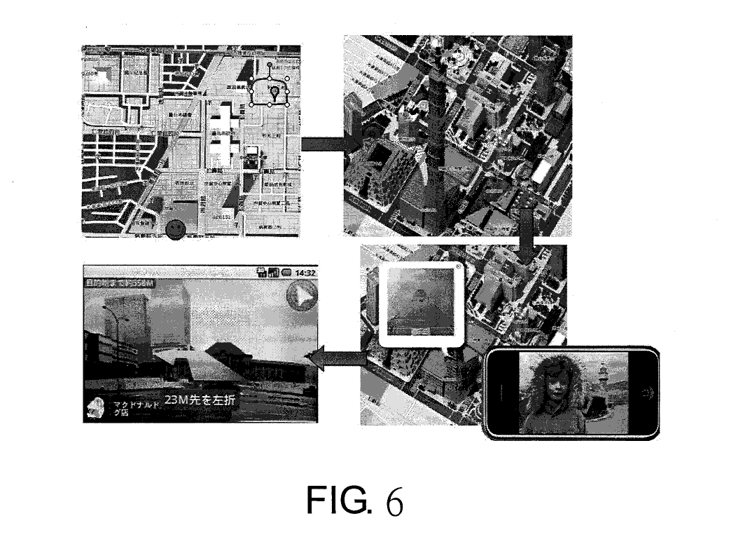

An example of a possible circumstance for an actual interactive navigation is described hereafter to illustrate a possible application of the disclosure. FIG. 5 is a schematic view depicting a usage scenario of the disclosure applied in destination recommendation and direction guidance. FIG. 6 is a schematic view depicting a usage scenario of the disclosure applied in interactive navigation. Please refer to both FIGS. 5 and 6. After a live connection is created between the mobile devices (e.g., application apparatuses) of the traveler and the local real-time helper, a software on the mobile devices displays a map, and the two parties share the location data thereof to each other. Moreover, the traveler utilizes real-time voice communication to describe a desired destination, and accordingly the local real-time helper finds the destination on the map and plans a route from the position of the traveler to the destination. Additionally, a virtual brush may be employed to annotate important landmarks, bus stops, and related information on the screen of the mobile device. The screens seen by the traveler and the local real-time helper are rendered in sync. In other words, after the local real-time helper operates the map or marks the annotations, the screen of the traveler displays the same image. Therefore, the traveler can easily reach the desired destination by following the directions on the screen. The local real-time helper may further provide information possibly needed by the traveler. For example, the helper may encircle on the map special souvenir shops, flavorful restaurants, or other places of interest near the traveler's position, and recommend the traveler to experience the local culture.

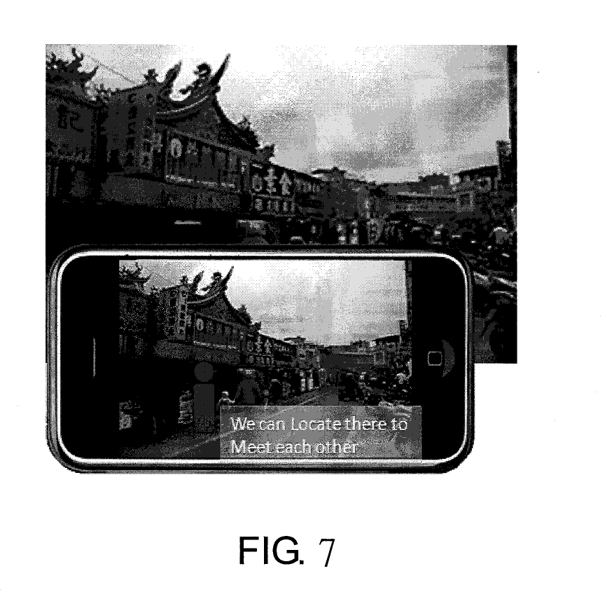

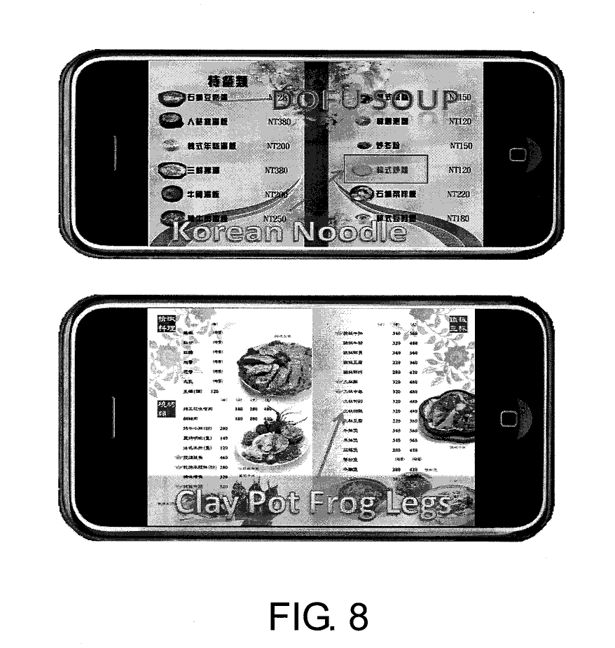

When the traveler is faced with a perplexing problem or a urgent situation, for instance the traveler may not know where best to rendezvous, how to read the menu, or the traveler may be lost, wants to know how to ride the public transportation, or wants to find the nearest place to eat or shop, and so on. By using the system of travel service according to the disclosure, a real-time helper well versed with the local language and culture can be found and a live connection can be created. FIG. 7 is a schematic view depicting a usage scenario of the disclosure applied in designating a rendezvous point. Please refer to FIG. 7. The traveler uses a camera device on the application apparatus (e.g., a mobile phone) and captures a photo of the current surrounding environment or a perplexing location. The photo is immediately sent to the real-time helper. Accordingly, the real-time helper assists the traveler in determining an interesting destination, a rendezvous point, and so on. Thereafter, the real-time helper may annotate on the photo the rendezvous point, step by step. At this time, the annotations on the map and the voice instructions synchronously appear on the application apparatuses in real time, and therefore the instructions can be easily understood by the traveler and the concerns thereof are resolved. FIG. 8 is a schematic view depicting a usage scenario of the disclosure applied in menu translation and explanation. Please refer to FIG. 8. When the traveler orders a meal and takes a photo of the menu, the menu photo is automatically transmitted to the mobile phone of the local real-time helper, and accordingly the local real-time helper assists in the meal ordering by voice communication or by directly annotating on the menu photo.

In view of the foregoing, an embodiment of the disclosure employs an intelligent matching mechanism. Through a filtering process, a helper capable of speaking a common language with the traveler is found. Moreover, a live connection is created between the traveler and the helper, such that the helper can remotely resolve the problems met by the traveler through the functions provided by the system in the disclosure.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method of travel service adapted for a system of travel service comprising a server and an application apparatus, the method of travel service comprising:
sending a request from a traveler through the application apparatus;
finding a real-time helper through the server, wherein the real-time helper has a communication capability of a specific language used by the traveler;
sending the request to the helper; and
creating a live connection between the traveler and the real-time helper to provide travel services to satisfy the request, wherein the live connection comprises real-time voice communication.

2. The method as claimed in claim 1, wherein the step of finding the real-time helper comprises:
providing a plurality of candidate helpers with the server, wherein all of the candidate helpers have the communication capability of the specific language used by the traveler; and
selecting an available candidate helper from the candidate helpers as the real-time helper.

3. The method as claimed in claim 2, further comprising:
when the problem corresponding to the request has not been resolved, selecting another available candidate helper from the candidate helpers as the real-time helper.

4. The method as claimed in claim 3, further comprising:
when the real-time helper cannot be found from the candidate helpers, a service personnel from the service personnels of a service center is selected as the real-time helper.

5. The method as claimed in claim 2, further comprising:
when the problem corresponding to the request has been resolved, having the traveler input a reputation score related to the real-time helper or having the traveler input a dual positive/negative rating, when the traveler inputs the dual rating, the determining factors of the reputation score of the real-time helper comprises an average number of service cases and a ratio of positive ratings.

6. The method as claimed in claim 5, wherein the system of travel service further comprises a social networking system, and the step of providing the candidate helpers comprises:
creating a database related to the candidate helpers through the social networking system; and
searching in the database the N candidate helpers having the communication capability of the specific language and the highest reputation scores, wherein N is a positive integer larger than 1.

7. The method as claimed in claim 1, wherein the live connection further comprises real-time data communication, the method further comprising:
determining a current position of the application apparatus;
sending the current position to the real-time helper; and
sending and receiving a control signal and data for synchronizing an application status between the application apparatus and the real-time helper, so as to engage in interactive navigation.

8. A method of travel service adapted for a system of travel service comprising a server and an application apparatus, the method of travel service comprising:
sending a request from a traveler through the application apparatus;
providing a plurality of candidate helpers through the server, wherein the candidate helpers have a communication capability of a specific language used by the traveler;
sending the request to the candidate helpers;
when one of the candidate helpers accepts the request, setting the candidate helper accepting the request as a real-time helper; and
creating a live connection between the traveler and the real-time helper to provide travel services to satisfy the request, wherein the live connection includes real-time voice communication.

9. The method as claimed in claim 8, further comprising:
when the candidate helpers cannot be found, or when none of the candidate helpers accepts the request, or when the problem corresponding to the request has not been resolved, then the request is redirected to a service center, and a service personnel from the service personnels of the service center is selected as the real-time helper.

10. The method as claimed in claim 8, further comprising:
when the problem corresponding to the request has been resolved, having the traveler input a reputation score related to the real-time helper or having the traveler input a dual positive/negative rating, when the traveler inputs the dual rating, the determining factors of the reputation score of the real-time helper comprises an average number of service cases and a ratio of positive ratings.

11. The method as claimed in claim 10, wherein the system of travel service further comprises a social networking system, and the step of providing the candidate helpers comprises:
creating a database related to the candidate helpers through the social networking system; and
searching in the database the N candidate helpers having the communication capability of the specific language and the highest reputation scores, wherein N is a positive integer larger than 1.

12. The method as claimed in claim 8, wherein the live connection further comprises real-time data communication, the method further comprising:
determining a current position of the application apparatus;
sending the current position to the real-time helper; and
sending and receiving a control signal and data for synchronizing an application status between the application apparatus and the real-time helper, so as to engage in interactive navigation.

13. A system of travel service comprising:
an application apparatus for a traveler sending a request through the application apparatus; and
a server for finding a real-time helper through the server, wherein the real-time helper has a communication capability of a specific language used by the traveler,
the system of travel service creating a live connection between the traveler and the real-time helper to provide travel services to satisfy the request, wherein the live connection includes real-time voice communication.

14. The system as claimed in claim 13, wherein the server comprises a storage device, and the server provides a matching service for searching N candidate helpers from a database in the storage device, wherein all of the candidate helpers have the communication capability of the specific language, N is a positive integer larger than 1, an available candidate helper from the candidate helpers is selected as the real-time helper, and the system of travel service sends the request to the real-time helper.

15. The system as claimed in claim 14, wherein when the problem corresponding to the request has not been resolved, the matching service selects another available candidate helper from the candidate helpers as the real-time helper, and when the real-time helper cannot be found from the candidate helpers, a service personnel from the service personnels of a service center is selected as the real-time helper.

16. The system as claimed in claim 14, wherein the server provides a rating manager compiling and evaluating a reputation score of the real-time helper, when the problem corresponding to the request has been resolved, the traveler inputs the reputation score related to the real-time helper or the traveler inputs a dual positive/negative rating, when the traveler inputs the dual rating, the determining factors of the reputation score of the real-time helper comprises an average number of service cases and a ratio of positive ratings, the system further comprising:
a social networking system for creating the database related to the candidate helpers,
the matching service searching in the database the N candidate helpers having the communication capability of the specific language and the highest reputation scores.

17. The system as claimed in claim 13, wherein the server comprises a storage device, and the server provides a matching service for searching N candidate helpers from a database in the storage device, wherein all of the candidate helpers have the communication capability of the specific language, N is a positive integer larger than 1, the server sending the request to the candidate helpers, and when one of the candidate helpers accepts the request, the candidate helper accepting the request is selected as the real-time helper.

18. The system as claimed in claim 17, wherein when the problem corresponding to the request has not been resolved, the matching service selects a service personnel from the service personnels of the service center as the real-time helper.

19. The system as claimed in claim 17, wherein the server provides a rating manager compiling and evaluating a reputation score of the real-time helper, when the problem corresponding to the request has been resolved, the traveler inputs the reputation score related to the real-time helper or the traveler inputs a dual positive/negative rating, when the traveler inputs the dual rating, the determining factors of the reputation score of the real-time helper comprises an average number of service cases and a ratio of positive ratings, the system further comprising:
a social networking system for creating the database related to the candidate helpers,
the matching service searching in the database the N candidate helpers having the communication capability of the specific language and the highest reputation scores.

20. The system as claimed in claim 13, wherein the live connection further comprises real-time data communication, and the application apparatus further comprises:
a positioning module for determining a current position of the application apparatus, the application apparatus sending the current position to the real-time helper, and sending and receiving a control signal and data,
the server providing a synchronization service for synchronizing an application status between the application apparatus and the real-time helper, so as to engage in interactive navigation.

21. An application apparatus of travel service adapted for a system of travel service further comprising a server,wherein after a traveler sends a request through the application apparatus, the server finds a real-time helper, wherein the real-time helper has a communication capability of a specific language used by the traveler, the system of travel service creating a live connection between the real-time helper and the traveler to provide travel services to satisfy the request, wherein the live connection comprises real-time voice communication.

22. The application apparatus as claimed in claim 21,
wherein the live connection further comprises real-time data communication, the application apparatus comprising a positioning module for determining a current position of the application apparatus, the application apparatus sending the current position to the real-time helper, and sending and receiving a control signal and data, the server providing a synchronization service for synchronizing an application status between the application apparatus and the real-time helper, so as to engage in interactive navigation.

23. A server of travel service adapted for a system of travel service further comprising an application apparatus,
wherein after a traveler sends a request through the application apparatus, the server finds a real-time helper, wherein the real-time helper has a communication capability of a specific language used by the traveler, the system of travel service creating a live connection between the real-time helper and the traveler to provide travel services to satisfy the request, wherein the live connection comprises real-time voice communication.

24. The server as claimed in claim 23,
wherein the server comprises a storage device, and the server provides a matching service for searching N candidate helpers from a database in the storage device, wherein all of the candidate helpers have the communication capability of the specific language, N is a positive integer larger than 1, an available candidate helper from the candidate helpers is selected as the real-time helper, and the system of travel service sends the request to the real-time helper.

25. The server as claimed in claim 24,
wherein when the problem corresponding to the request has not been resolved, the matching service selects another available candidate helper from the candidate helpers as the real-time helper, and when the real-time helper cannot be found from the candidate helpers, a service personnel from the service personnels of a service center is selected as the real-time helper.

26. The server as claimed in claim 24,
wherein the server provides a rating manager compiling and evaluating a reputation score of the real-time helper, when the problem corresponding to the request has been resolved, the traveler inputs the reputation score related to the real-time helper or the traveler inputs a dual positive/negative rating, when the traveler inputs the dual rating, the determining factors of the reputation score of the real-time helper comprises an average number of service cases and a ratio of positive ratings, the system of travel service further comprising a social networking system creating the database related to the candidate helpers, and the matching service searches in the database the N candidate helpers having the communication capability of the specific language and the highest reputation scores.

27. The server as claimed in claim 23,
wherein the server comprises a storage device, and the server provides a matching service for searching N candidate helpers from a database in the storage device, wherein all of the candidate helpers have the communication capability of the specific language, N is a positive integer larger than 1, the server sending the request to the candidate helpers, and when one of the candidate helpers accepts the request, the candidate helper accepting the request is selected as the real-time helper.

28. The server as claimed in claim 27,
wherein when the problem corresponding to the request has not been resolved, the matching service selects a service personnel from the service personnels of the service center as the real-time helper.

29. The server as claimed in claim 27,
wherein the server provides a rating manager compiling and evaluating a reputation score of the real-time helper, when the problem corresponding to the request has been resolved, the traveler inputs the reputation score related to the real-time helper or the traveler inputs a dual positive/negative rating, when the traveler inputs the dual rating, the determining factors of the reputation score of the real-time helper comprises an average number of service cases and a ratio of positive ratings, and the system of travel service further comprising a social networking system creating the database related to the candidate helpers, the matching service searching in the database the N candidate helpers having the communication capability of the specific language and the highest reputation scores.

30. The server as claimed in claim 23,
wherein the live connection further comprises real-time data communication, the application apparatus comprising a positioning module for determining a current position of the application apparatus, the application apparatus sending the current position to the real-time helper, and sending and receiving a control signal and data, the server providing a synchronization service for synchronizing an application status between the application apparatus and the real-time helper, so as to engage in interactive navigation.
